(19) United States
(12) Patent Application Publication
(10) Pub. No.: US 2006/0236279 A1
(43) Pub. Date: Oct. 19, 2006

(54) Design supporting apparatus, design supporting method, and computer product

(75) Inventor: Katsumi Homma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/167,296

(22) Filed: Jun. 28, 2005

(30) Foreign Application Priority Data
Mar. 24, 2005 (JP) 2005-086146

(51) Int. Cl. G06F 17/50

(52) U.S. Cl. 716/6

(57) ABSTRACT

A design supporting apparatus includes a detecting unit that detects a path constituting a circuit from circuit information of the circuit; a sensitivity-equation producing unit that produces a calculating equation for a sensitivity indicating a change rate of a parameter regarding a delay of a circuit element constituting the path, for every path detected; and an element-sensitivity calculating unit that calculates a sensitivity of the circuit element by using the calculating equation produced.

### CROSS-REFERENCE TO RELATED APPLICATIONS

This application is based upon and claims the benefit of priority from the prior Japanese Patent Application No. 2005-086146, filed on Mar. 24, 2005, the entire contents of which are incorporated herein by reference.

### BACKGROUND OF THE INVENTION

1. Field of the Invention

The present invention relates to a technology for supporting a design of a circuit by improving a circuit delay of the circuit.

2. Description of the Related Art

In recent year, influence of a statistical factor (such as a process fluctuation) on very-large-scale integrated circuit (VLSI) manufacturing becomes large due to fineness of a process. To manufacture a circuit having a performance required in VLSI design with an excellent yield, it is required to provide a delay improving technique obtained by considering the influence in advance. As a conventional technology, a statistical delay simulation apparatus that performs delay simulation to LSI by obtaining a statistical delay amount according to any one of characteristic fluctuation or operation condition of a circuit cell in LSI and both has been disclosed (see, for example, Japanese Patent Application Laid-Open No. 2004-252831).

In the conventional delay improving technique, however, there is such a problem that it is difficult to handle or process the statistical factor accurately. For example, when the statistical factor is handled in the conventional static delay analysis (STA), estimation is made with the worst value in the factor, which results in considerably pessimistic and inaccurate circuit delay value. Accordingly, due to occurrence of redesigning in circuit design, there is a problem that burden on a designer increases and prolonged designing term is caused.

In the conventional technique disclosed in the above literature, since a delay in circuit cells constituting an LSI is analyzed, one of circuit cells to be correct or improved preferentially is unclear, so that delay analysis to all the circuit cells must be conducted. Accordingly, much time is required for delay analysis of the whole large-scale integrated circuit (LSI), which results in prolonged design term like the above.

### SUMMARY OF THE INVENTION

It is an object of the present invention to at least solve the problems in the conventional technology.

A design supporting apparatus according to one aspect of the present invention includes a detecting unit that detects a path constituting a circuit from circuit information of the circuit; a sensitivity-equation producing unit that produces a calculating equation for a sensitivity indicating a change rate of a parameter regarding a delay of a circuit element constituting the path, for every path detected; and an element-sensitivity calculating unit that calculates a sensitivity of the circuit element by using the calculating equation produced.

A design supporting method according to another aspect of the present invention includes detecting a path constituting a circuit from circuit information of the circuit; producing a calculating equation for a sensitivity indicating a change rate of a parameter regarding a delay of a circuit element constituting the path, for every path detected; and calculating a sensitivity of the circuit element by using the calculating equation produced.

A computer-readable recording medium according to still another aspect of the present invention stores a computer program that causes a computer to execute the above design supporting method according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram showing a hardware configuration of a design supporting apparatus according to an embodiment of the present invention;

FIG. 2 is an explanatory diagram showing a circuit element library according to the present embodiment;

FIG. 3 is a block diagram showing a functional configuration of the design supporting apparatus according to the present embodiment;

FIG. 4 is an explanatory diagram showing one example of a path;

FIG. 5 is a flowchart of a design supporting processing procedure (a first procedure) according to the present embodiment; and

FIG. 6 is a flowchart of a design supporting processing procedure (a second procedure) according to the present embodiment.

### DETAILED DESCRIPTION OF THE PREFERRED EMBODIMENTS

Exemplary embodiments of a design supporting apparatus, a design supporting method, and a computer product according to the present invention will be explained below in detail with reference to the accompanying drawings.

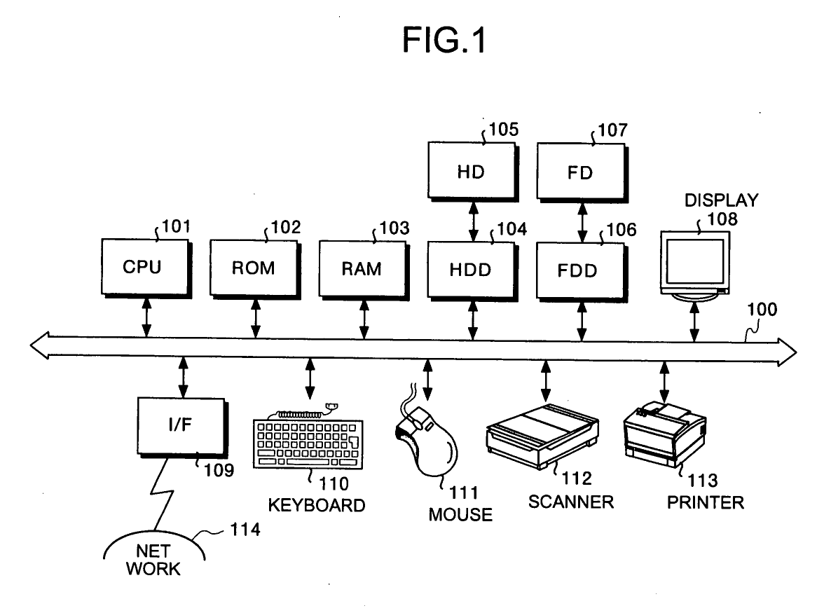

FIG. 1 is a block diagram showing a hardware configuration of a design supporting apparatus according to an embodiment of the invention. A design supporting apparatus includes a central processing unit (CPU) 101, a read only memory (ROM) 102, a random access memory (RAM) 103, a hard disk drive (HDD) 104, a hard disk (HD) 105, a flexible disk drive (FDD) 106, a flexible disk (FD) 107 as a detachable recording medium, a display 108, an interface (I/F) 109, a keyboard 110, a mouse 111, a scanner 112, and a printer 113. All the constituent units are connected via a bus 100.

The CPU 101 serves to control the entire of the design supporting apparatus. The ROM 102 stores programs such as a boot program. The RAM 103 is used as a work area for the CPU 101. The HDD 104 controls read/write of data to the HD 105 according to control the CPU 101. The HD 105 stores data written under control of the HDD 104.

The FDD 106 controls read/write of data to the FD 107 according to control of the CPU 101. The FD 107 stores data written under control of the FDD 106 or causes the design supporting apparatus to read data stored in the FD 107.

The detachable recording medium can be a compact disk-read only memory (CD-ROM), a compact disk-recordable (CD-R), a compact disk-rewritable (CD-RW), a magneto-optical (MO) disk, a digital versatile disk (DVD), or a memory card other than the FD 107. The display 108 displays not only a cursor, an icon, and a toolbox, but also data such as a document, an image, or functional information. The display 108 can be a cathode ray tube (CRT), a thin-film-transistor (TFT) liquid crystal display, or a plasma display.

The I/F 109 is connected to a network 114 such as Internet via a communication line, and it is connected to another apparatus via the network 114. The I/F 109 serves as an interface between the network 114 and internal devices in the design supporting apparatus, and it controls input/output of data from/to an external apparatus. As the I/F 109, a modem, a local-area-network (LAN) adapter, or the like can be used.

The keyboard 110 is provided with keys for inputting characters, numerals, various instructions, or the like, and it allows data inputting. The keyboard 110 can be an input pad or a ten key of a touch panel type. The mouse 111 is for performing movement and range selection of the cursor or movement of a window or size change thereof. The mouse 111 may be track ball, a joystick, or the like if it is provided with similar functions as a pointing device.

The scanner 112 optically reads an image to take image data into the design supporting apparatus. Incidentally, the scanner 112 may have an optical-character-recognition (OCR) function. The printer 113 prints image data or document data. As the printer 113, for example, a laser printer or an inkjet printer may be used.

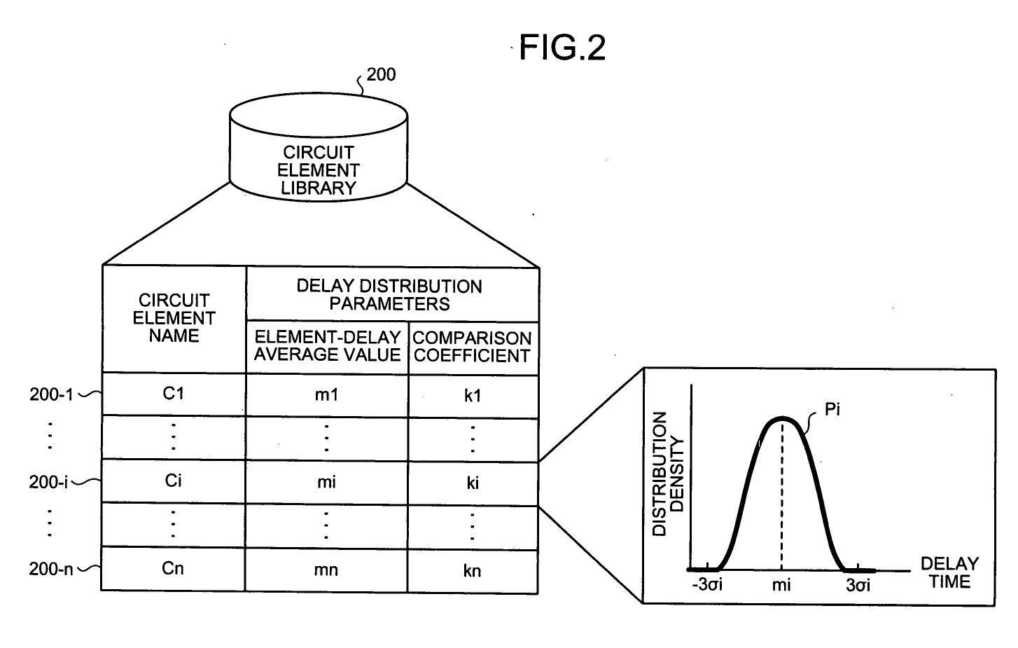

FIG. 2 is an explanatory diagram showing a circuit element library according to the present embodiment. A circuit element library 200 stores circuit-element-delay-distribution information 200-1 to 200-n for each circuit element. The circuit-element-delay-distribution information 200-1 to 200-n has a circuit element name and delay distribution parameters to clock for each circuit element.

The delay distribution parameters have an average value of clock delay values of the circuit element (element-delay average value) and a comparison coefficient. A standard deviation of the circuit element can be calculated by multiplying the element-delay average value and the comparison coefficient. For example, the circuit-element-delay-distribution information 200-i includes an element-delay average value mi and a comparison coefficient ki of a circuit element Ci. Accordingly, a standard deviation σi of the circuit element Ci can be expressed by
σi=ki×mi (1)

Accordingly, a delay distribution of the circuit element Ci can be represented by a probability density function Pi of a normal distribution. The circuit element may be a buffer, an inverter, a logic gate, or the like. Specifically, a function of the circuit element library 200 can be realized by using such a recording medium, for example, the ROM 102, the RAM 103, or the HD105 shown in FIG. 1.

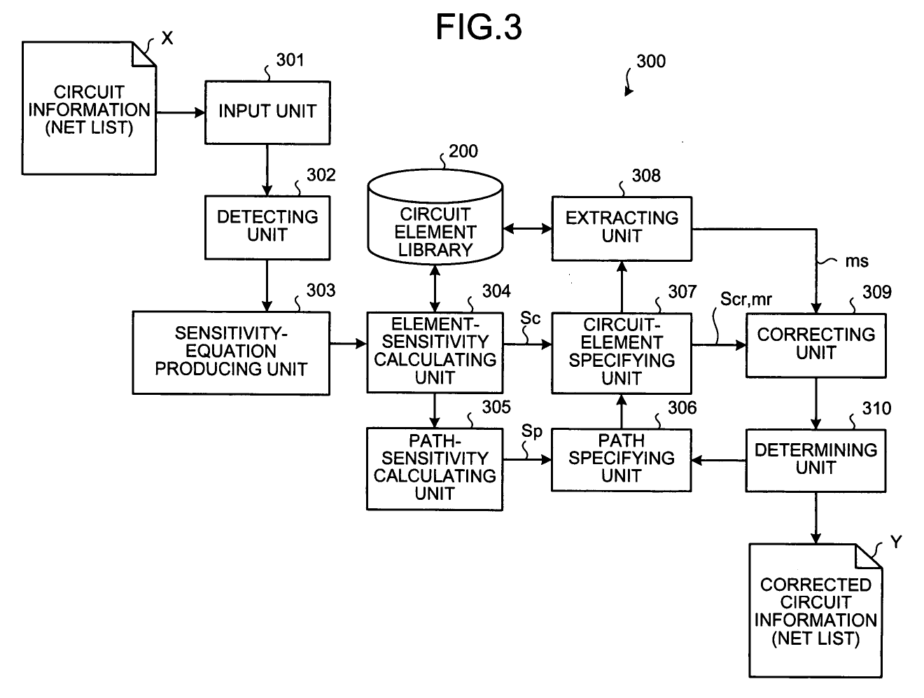

FIG. 3 is a block diagram showing a functional configuration of the design supporting apparatus according to the present embodiment. A design supporting apparatus 300 includes the circuit element library 200, an input unit 301, a detecting unit 302, a sensitivity-equation producing unit 303, an element-sensitivity calculating unit 304, a path-sensitivity calculating unit 305, a path specifying unit 306, a circuit-element specifying unit 307, an extracting unit 308, a correcting unit 309, and a determining unit 310.

The input unit 301 receives an input of circuit information X about an object circuit. The circuit information X is information indicating a connection relationship among circuit elements constituting the object circuit. For example, a net list obtained by logically composing HDL description of RTL can be used as the information.

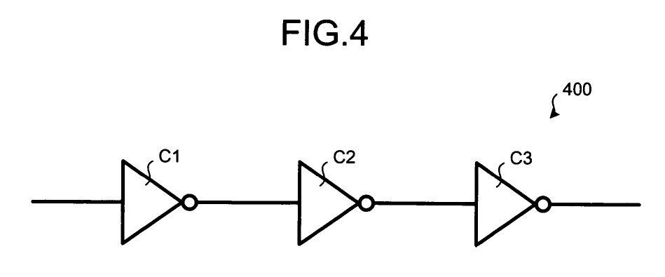

The detecting unit 302 detects a path constituting the object circuit from the circuit information X about the object circuit. Specifically, the path can be detected from the description in the net list. The path detected can include a clock path, a data path, or a composite path obtained by branching these paths or joining them. FIG. 4 is an explanatory diagram showing one example of the path. The path is a data path configured by connecting three circuit elements in series.

The sensitivity-equation producing unit 303 produces a calculating equation for sensitivity (hereinafter, “sensitivity equation”) indicating a change rate of parameters regarding delay in respective circuit elements constituting the path detected by the detecting unit 302. Specifically, a statistical maximum delay value of a path is formulated using delay distribution parameters (for example, the element-delay average value and the standard deviation) of the circuit elements constituting the path so that a relational equation between the statistical maximum delay value and the delay distribution parameters of a path (hereinafter, “statistical-maximum-delay equation”) is prepared.

The term “statistical maximum delay value” means a delay value taking, in a delay probability distribution, a sufficient large accumulation probability (for example, 99%). For example, in the path shown in FIG. 4, a relational equation between the statistical maximum delay value Dp of the path and the delay distribution parameter of circuit elements constituting the path can be expressed by
Dp=m1+m2+m3+3√k1²●m1²+k2²●m2²+k3²●m3² (2)

In Eq. (2), since the delay distribution parameters do not refer to the circuit element library 200, they are handled as variables. The sensitivity-equation producing unit 303 can produce a sensitivity equation for the respective circuit elements constituting the path by partially differentiating the statistical-maximum-delay equation of the path.

That is, the term “sensitivity” means a change rate of a circuit delay value of the object circuit obtained when finely correcting the variable (specifically the element-delay average value) (for example, by 1 ps) in the statistical-maximum-delay equation. For example, a sensitivity equation expressed by Eq. (3) can be obtained regarding the path shown in FIG. 4 by partially differentiating Eq. (2).
Scj=∂Dp/∂mj=1+3●kj²●mj/√k1²●m1²+k2²●m2²+k3²●m3² (3)

In the sensitivity-equation producing unit 303, a sensitivity equation for respective circuit elements constituting a path can be calculated for each path. Accordingly, sensitivity equations for all the circuit elements constituting the object circuit can be calculated.

The element-sensitivity calculating unit 304 calculates a sensitivity of a circuit element (hereinafter, “element sensitivity Sc”) using the sensitivity equation produced by the sensitivity-equation producing unit 303. Specifically, delay distribution parameters (the element-delay average value and the comparison coefficient) of the respective circuit elements constituting the path are extracted from the circuit element library 200 according to guidance of the sensitivity equation, so that the element sensitivity Sc can be calculated by substituting the delay distribution parameters for the sensitive equation.

The term “element sensitivity Sc” means a change rate of a circuit delay value in an object circuit obtained when element-delay average values of circuit elements constituting a path is finely corrected. For example, the element sensitivity Scj of a circuit element Cj (in this case, j=1, 2, 3) is calculated by extracting element-delay average values m1 to m3 and comparison coefficients k1 to k3 of respective circuit elements C1 to C3 constituting a path from the circuit element library 200.

The path-sensitivity calculating unit 305 produces, for each path, a sensitivity of the path (hereinafter, “path sensitivity Sp”) using the sensitivity equation produced by the sensitivity-equation producing unit 303. Here, the path sensitivity Sp indicates a change rate of a circuit delay value occurring in an object circuit when any of circuit elements constituting a path is finely corrected. For example, the maximum sensitivity of element sensitivities of circuit elements constituting a path may be set as the path sensitivity. The path sensitivity Sp may be a total sum or an average value of element sensitivities Sc of all circuit elements constituting a path.

The path specifying unit 306 specifies a path to be corrected based upon respective path sensitivities Sp calculated by the path-sensitivity calculating unit 305. Specifically, for example, a path with the maximum path sensitivity of paths may be specified as the path to be corrected (hereinafter, “correction object path”).

The circuit-element specifying unit 307 specifies a circuit element to be corrected (hereinafter, “correction-object circuit element”) from circuit elements constituting a path based upon the element sensitivities Sc calculated by the element-sensitivity calculating unit 304. Specifically, the circuit-element specifying unit 307 specifies the correction-object circuit element of circuit elements constituting the correction object path specified by the path specifying unit 306 based upon the element sensitivities calculated by the element-sensitivity calculating unit 304. Specifically, the circuit element with the maximum element sensitivity of circuit elements constituting a correction object path may be specified as the correction-object circuit element, for example.

The extracting unit 308 sequentially extracts element-delay average values from the circuit element library 200, when the correction-object circuit element is specified by the circuit-element specifying unit 307. The extracting unit 308 outputs extracted element-delay average values (hereinafter, “extracted element-delay average values ms”) to the correcting unit 309.

The correcting unit 309 corrects a circuit delay value Pd of the object circuit using the element sensitivities Scr and the element-delay average value mr of the correction-object circuit element specified by the circuit-element specifying unit 307. Specifically, for example, the correcting unit 309 calculates the circuit delay value Rd after corrected according to Eq. (4).
Rd=Pd+Scr×(ms−mr) (4)

In Eq. (4), (ms−mr) on a right-hand side represents a fine correction value Δm of the element-delay average value. The right-hand-side term Scr×(ms−mr) represents an improvement value to a circuit delay. That is, since the element sensitivity Scr becomes large in proportion to the improvement value, when the element sensitivity Scr is large, a significant improvement in circuit delay can be achieve with a small improvement value. The correcting unit 309 detects the extraction element-delay average value ms that minimizes the value of (5), using the circuit delay value Rd after corrected and the object circuit delay value Td of the object circuit.
|Td−Rd| (5)

When the extraction element-delay average value ms satisfying the minimum is detected, a circuit delay value Rd after corrected at this time is defined as a new circuit delay value Pd. The circuit information X is corrected by rewriting description about the correction-object circuit element in the circuit information X to description about a circuit element with the extraction element-delay average value ms that minimizes the value of (5).

The determining unit 310 determines whether the circuit delay in the object circuit has been improved using the circuit delay value Rd after corrected. Specifically, for example, as shown in following inequality (6), whether the new circuit delay value Pd substituted from the circuit delay value Rd after corrected is a target circuit delay value Td of the object circuit or less is determined.
Td≧Pd (6)

When inequality (6) is satisfied, corrected circuit information Y is outputted. Thereby, the circuit delay in the object circuit can be improved. On the other hand, when inequality (6) is not satisfied, a circuit element with the maximum element sensitivity Sc is specified from unspecified circuit elements in the correction object path by the circuit-element specifying unit 307. When there is not any unspecified circuit element, a path with the maximum path sensitivity Sp is specified from unspecified paths by the path specifying unit 306. Thereby, correction can be performed automatically until the circuit delay in the object circuit is improved.

Specifically, functions of the input unit 301, the detecting unit 302, the sensitivity-equation producing unit 303, the element-sensitivity calculating unit 304, the path-sensitivity calculating unit 305, the path specifying unit 306, the circuit-element specifying unit 307, the extracting unit 308, the correcting unit 309, and the determining unit 310 are can be realized by the CPU 101 executing programs recorded in such a recording medium as, for example, the ROM 102, the RAM 103, or the HD 105 shown in FIG. 1 or through the I/F 109.

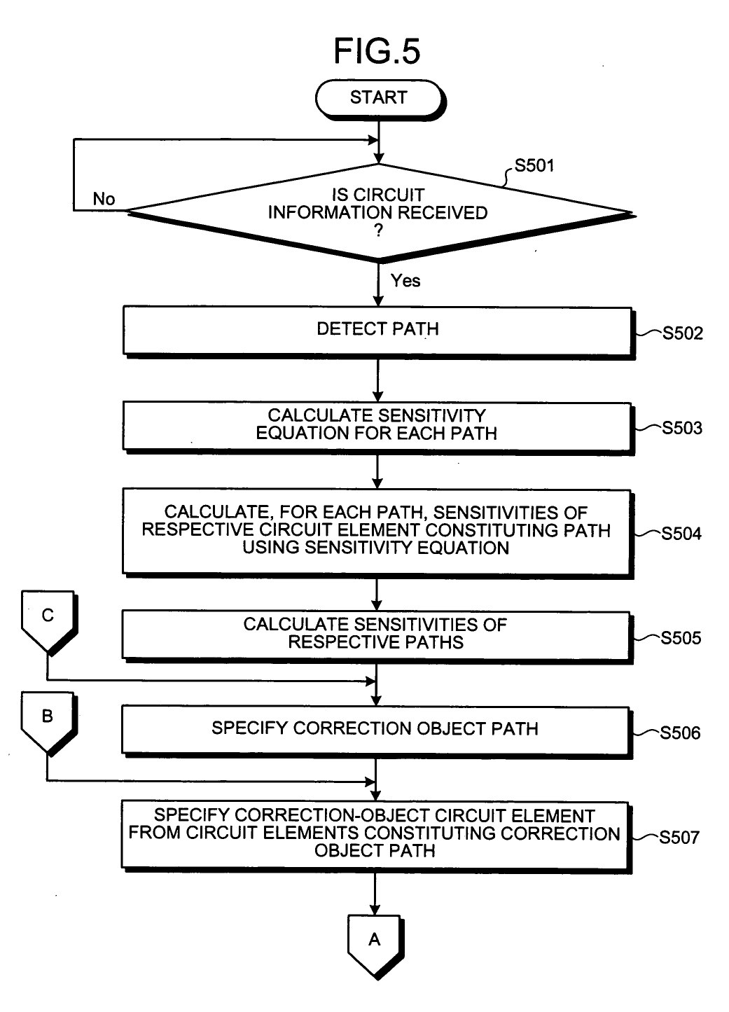

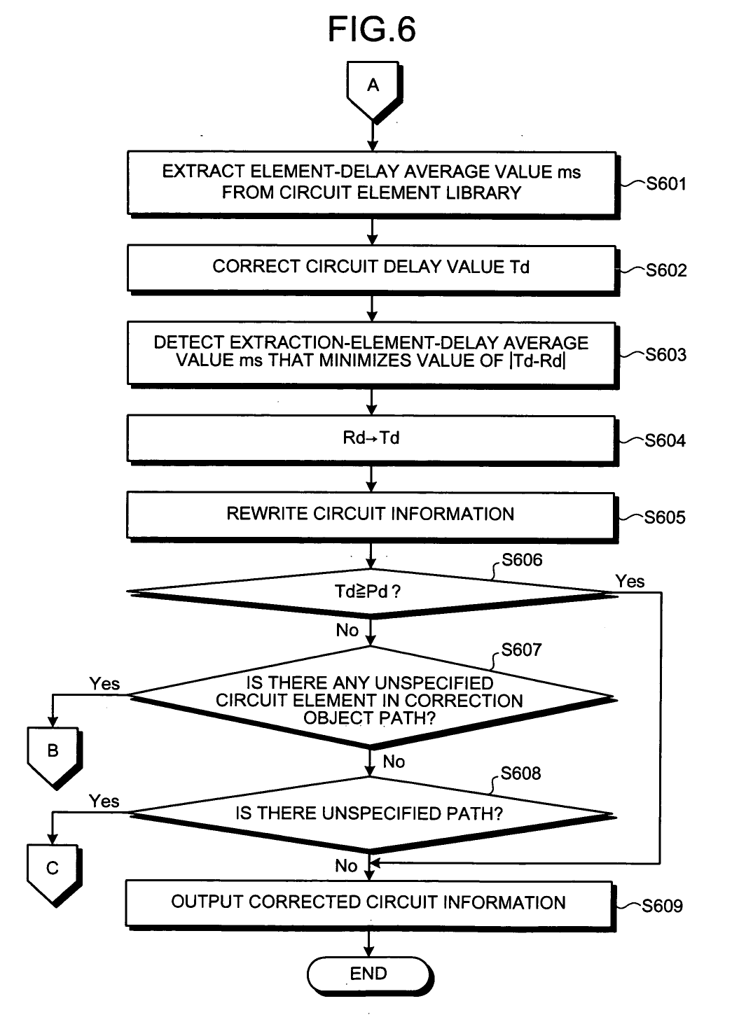

FIGS. 5 and 6 are flowcharts of a design supporting processing procedure according to the present embodiment. In FIG. 5, when circuit information X about an object circuit is inputted through the input unit 301 (“YES” at step S501), the detecting unit 302 detects a path in the object circuit (step S502).

The sensitivity-equation producing unit 303 calculates a sensitivity equation for each path detected (step S503). Next, the element-sensitivity calculating unit 304 calculates element sensitivities Sc of respective circuit elements constituting the path for each path using the sensitivity equations (step S504).

The path-sensitivity calculating unit 305 calculates path sensitivities Sp of respective paths (step S505). The path specifying unit 306 specifies a path with the maximum path sensitivity Sp (the correction object path) from the paths (step S506). Next, the circuit-element specifying unit 307 specifies a circuit element with the maximum element sensitivity (the correction-object circuit element) from the circuit elements constituting the correction object path (step S507).

When the correction-object circuit element is specified, the extracting unit 308 extracts element-delay average values ms of respective circuit elements from the circuit element library 200 (step S601 in FIG. 6). Next, the correcting unit 309 calculates a circuit delay value Rd by correcting a current circuit delay value Td (step S602).

The extracting unit 308 detects an extraction element-delay average value ms that minimizes the value of (5) (step S603) to set the circuit delay value Rd after corrected as a current circuit delay value Td (step S604). The correcting unit 309 rewrites description about the corrected object circuit element in the circuit information X to description about a circuit element having the extraction element-delay average value ms (step S605).

The determining unit 310 determines whether the circuit delay in the object circuit has been improved, namely, inequality (6) is satisfied (step S606). When inequality (6) is not satisfied (“NO” at step S606), the determining unit 310 determines whether there is any unspecified circuit element in the correction object path (step S607). When there is an unspecified circuit element(s) (“YES” at step S607), the processing moves to step S507, where the circuit-element specifying unit 307 newly specifies a correction-object circuit element. Thereby, correction and improvement processing to circuit delay in the correction object path can be automatically performed.

On the other hand, when there is not any unspecified circuit element (“NO” at step S607), whether there is a unspecified circuit element(s) is determined (step S608). When there is an unspecified path (“YES” at step S608), the processing moves to step S506, where the circuit-element specifying unit 307 specifies a correction-object circuit element newly. Thereby, even if the circuit delay in the object circuit has not been improved by correcting the circuit elements constituting the correction object path, correction and improvement processing to circuit delay in the object circuit can be automatically performed by specifying a correction object path newly.

On the other hand, when there is no unspecified path (“NO” at step S608), or when inequality (6) is satisfied in step S606 (“YES” at step S606), corrected circuit information Y rewritten according to the previous corrections performed is outputted (step S609).

According to the present embodiment, therefore, a circuit element with a high improvement possibility for circuit delay can be detected preferentially and automatically. Especially, a path including a circuit element with a high improvement possibility for circuit delay can be detected preferentially and automatically by specifying a path. Accordingly, speed-up of a delay improving processing to an object circuit can be achieved.

Circuit information can be corrected. Especially, when a circuit delay is improved, circuit information with the improved circuit delay can be automatically obtained. A delay improving processing can be preferentially continued from a circuit element or a path with a high sensitivity until circuit delay in an object circuit is improved, and a efficient delay improving processing can be performed considering the statistical factor.

As described above, according to the present embodiment, reduction in burden on a designer or reduction in design term can be achieved by improving circuit delay in an object circuit efficiently and accurately.

The design supporting method explained in the present embodiment can be realized by performing a preliminarily prepared program in such a computer as a personal computer or a workstation. The program is recorded on such a computer readable recording medium as a hard disk, a flexible disk, a CD-ROM, an MO, or a DVD and it is read from the recording medium and executed by a computer. The program may be a transmission medium that can be distributed via a network such as the internet.

According to the present invention, reduction in burden on a designer and reduction in designing term can be achieved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A design supporting apparatus comprising:
a detecting unit that detects a path constituting a circuit from circuit information of the circuit;
a sensitivity-equation producing unit that produces a calculating equation for a sensitivity indicating a change rate of a parameter regarding a delay of a circuit element constituting the path, for every path detected; and
an element-sensitivity calculating unit that calculates a sensitivity of the circuit element by using the calculating equation produced.

2. The design supporting apparatus according to claim 1, further comprising a circuit-element specifying unit that specifies a circuit element to be corrected, based on the sensitivity of the circuit element calculated.

3. The design supporting apparatus according to claim 2, further comprising:
a path-sensitivity calculating unit that calculates a sensitivity of the path by using the calculating equation produced, for every path detected; and
a path specifying unit that specifies a path to be corrected, based on the sensitivity of the path calculated, wherein
the circuit-element specifying unit specifies the circuit element to be corrected from among a plurality of circuit elements constituting the path that is specified by the path specifying unit.

4. The design supporting apparatus according to claim 3, wherein the circuit-element specifying unit specifies a circuit element having a maximum sensitivity as the circuit element to be corrected.

5. The design supporting apparatus according to claim 3, further comprising:
a correcting unit that corrects a value of a circuit delay of the circuit using the sensitivity and a parameter regarding a delay of the circuit element specified by the circuit-element specifying unit; and
a determining unit that determines whether the circuit delay of the circuit is improved by the value of the circuit delay corrected by the correcting unit.

6. The design supporting apparatus according to claim 5, wherein the circuit-element specifying unit specifies, when the determining unit determines that the circuit delay of the circuit is not improved, a circuit element having a maximum sensitivity from among unspecified circuit elements as the circuit element to be corrected.

7. A design supporting method comprising:
detecting a path constituting a circuit from circuit information of the circuit;
producing a calculating equation for a sensitivity indicating a change rate of a parameter regarding a delay of a circuit element constituting the path, for every path detected; and
calculating a sensitivity of the circuit element by using the calculating equation produced.

8. The design supporting method according to claim 7, further comprising specifying a circuit element to be corrected, based on the sensitivity of the circuit element calculated.

9. The design supporting method according to claim 8, further comprising:
calculating a sensitivity of the path by using the calculating equation produced, for every path detected; and
specifying a path to be corrected, based on the sensitivity of the path calculated, wherein
the specifying a circuit element includes specifying the circuit element to be corrected from among a plurality of circuit elements constituting the path that is specified at the specifying a path.

10. The design supporting method according to claim 9, wherein the specifying a circuit element includes specifying a circuit element having a maximum sensitivity as the circuit element to be corrected.

11. The design supporting method according to claim 9, further comprising:
correcting a value of a circuit delay of the circuit using the sensitivity and a parameter regarding a delay of the circuit element specified; and
determining whether the circuit delay of the circuit is improved by the value of the circuit delay corrected.

12. The design supporting method according to claim 11, wherein the specifying a circuit element includes specifying, when it is determined that the circuit delay of the circuit is not improved, a circuit element having a maximum sensitivity from among unspecified circuit elements as the circuit element to be corrected.

13. A computer-readable recording medium that stores a computer program, wherein the computer program causes a computer to execute
detecting a path constituting a circuit from circuit information of the circuit;
producing a calculating equation for a sensitivity indicating a change rate of a parameter regarding a delay of a circuit element constituting the path, for every path detected; and
calculating a sensitivity of the circuit element by using the calculating equation produced.

14. The computer-readable recording medium according to claim 13, wherein the computer program further causes the computer to execute specifying a circuit element to be corrected, based on the sensitivity of the circuit element calculated.

15. The computer-readable recording medium according to claim 14, wherein the computer program further causes the computer to execute
calculating a sensitivity of the path by using the calculating equation produced, for every path detected; and
specifying a path to be corrected, based on the sensitivity of the path calculated, wherein
the specifying a circuit element includes specifying the circuit element to be corrected from among a plurality of circuit elements constituting the path that is specified at the specifying a path.

16. The computer-readable recording medium according to claim 15, wherein the specifying a circuit element includes specifying a circuit element having a maximum sensitivity as the circuit element to be corrected.

17. The computer-readable recording medium according to claim 15, wherein the computer program further causes the computer to execute
correcting a value of a circuit delay of the circuit using the sensitivity and a parameter regarding a delay of the circuit element specified; and
determining whether the circuit delay of the circuit is improved by the value of the circuit delay corrected.

18. The computer-readable recording medium according to claim 17, wherein the specifying a circuit element includes specifying, when it is determined that the circuit delay of the circuit is not improved, a circuit element having a maximum sensitivity from among unspecified circuit elements as the circuit element to be corrected.
